(19) United States
(12) Patent Application Publication
(10) Pub. No.: US 2009/0259777 A1
(43) Pub. Date: Oct. 15, 2009

(54) METHODS AND APPARATUS FOR EXTENDING SHORT RANGE DATA INTERFACES

(76) Inventors: Steven Douglas MARGERM, New Westminster (CA); Roderick Arthur BARMAN, Vancouver (CA); Stewart John KINGDON, Richmond (CA)

Correspondence Address: OYEN, WIGGS, GREEN & MUTALA LLP;480 - THE STATION, 601 WEST CORDOVA STREET, VANCOUVER, BC, V6B 1G1, CA

(21) Appl. No.: 12/413,448

(22) Filed: Mar. 27, 2009

Related U.S. Application Data
(60) Provisional application No. 61/040,515, filed on Mar. 28, 2008.

(51) Int. Cl. G06F 1/12

(52) U.S. Cl. 710/61

(57) ABSTRACT

A data link for the transfer of data between first and second devices has first and second interfaces operative to transmit data according to a first data transmission protocol and an intermediate link connecting the first and second interfaces. The intermediate link is operative to transmit data according to a second data transmission protocol. Clock domains of the first and second interfaces are synchronized to a clock domain of the intermediate link. The intermediate link may have master and slave clocks synchronized by operation of the second protocol. In some applications the first and second interfaces are Firewire™ interfaces and the intermediate link is an ethernet link. The data link may be applied to deliver data from a peripheral, such as a camera, to a computer.

### CROSS-REFERENCE TO RELATED APPLICATION

This application claims the benefit under 35 U.S.C. §119 of U.S. patent application No. 61/040,515 filed 28 Mar. 2008 and entitled METHODS AND APPARATUS FOR EXTENDING SHORT RANGE DATA INTERFACES, which is hereby incorporated herein by reference.

### TECHNICAL FIELD

The invention relates to data communication and, in particular, to extending short-range data interfaces. The invention has particular application to extending the length of IEEE 1394b interfaces.

### BACKGROUND

The IEEE 1394b interface (commonly known as ‘Firewire’) is often used to transfer time sensitive data streams such as audio or video between a peripheral device and a computer. The IEEE 1394b standard defines a high-speed serial bus. The IEEE 1394b interface is somewhat limited in the physical distance it can carry data by the maximum cable length of 4.5 m.

Gigabit Ethernet is a high-speed version of the dominant local area networking interface used to interconnect computers and other peripherals in home and office environments. The most common form of gigabit Ethernet can support network link distances over twisted-pair cables of up to 100 m.

There is a need for simple and cost-effective ways for extending the physical range of high speed serial interfaces such as IEEE 1394b interfaces.

### SUMMARY OF THE INVENTION

This invention provides extended high-speed serial data interfaces and methods and apparatus for extending high-speed serial data interfaces. In some embodiments the high-speed serial interface is an IEEE 1349b interface. In some embodiments, data from an IEEE 1349b interface is transported over an intermediate link, which may comprise a gigabit Ethernet link. The intermediate link transparently carries the IEEE 1349b traffic.

Further aspects of the invention and features of specific embodiments of the invention are described below.

### BRIEF DESCRIPTION OF THE DRAWINGS

The accompanying drawings illustrate non-limiting embodiments of the invention.

FIG. 1 is a block diagram of a prior art computer system comprising an IEEE 1394b interface.

FIG. 2 is a block diagram illustrating a computer system according to an embodiment of the invention.

FIG. 3 is a schematic illustration showing data flows in the computer system of FIG. 2.

FIG. 4 is a block diagram showing a clock synchronization system.

FIG. 5 is a block diagram illustrating a system for locking an IEEE 1394 clock to an ethernet clock.

FIG. 6 is a schematic diagram illustrating different clock domains in apparatus according to an example embodiment.

### DESCRIPTION

Throughout the following description, specific details are set forth in order to provide a more thorough understanding of the invention. However, the invention may be practiced without these particulars. In other instances, well-known elements have not been shown or described in detail to avoid unnecessarily obscuring the invention. Accordingly, the specification and drawings are to be regarded in an illustrative, rather than a restrictive, sense.

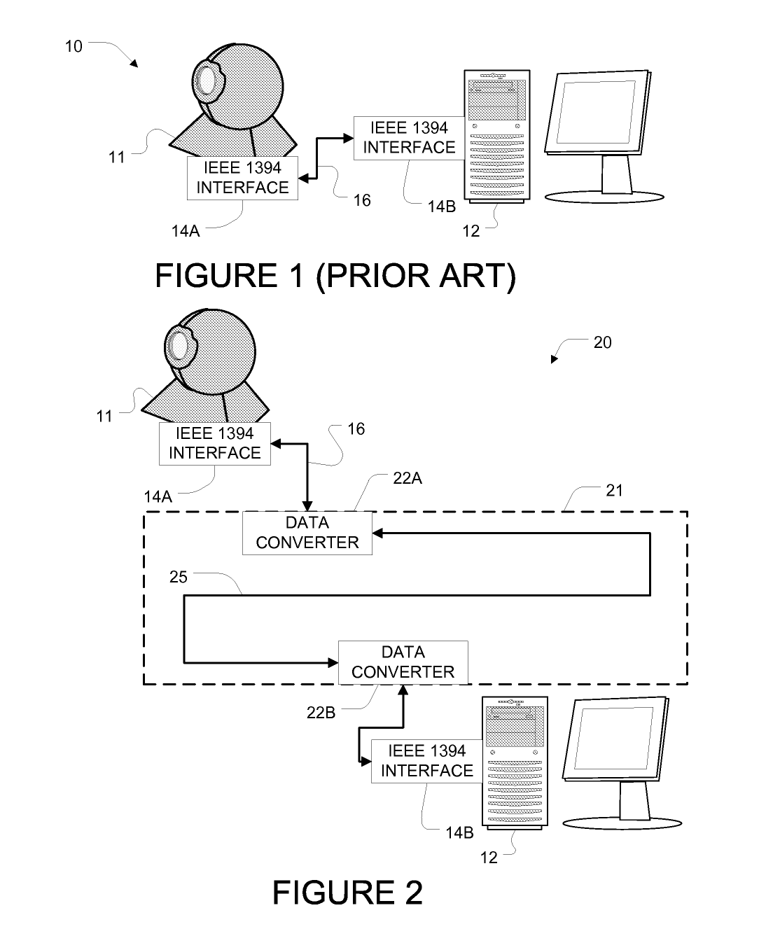

FIG. 1 shows a prior art computer system 10 in which a data source, in this example a camera 11 transmits data to a destination, in this case a computer 12. Camera 11 and computer 12 each comprise an IEEE 1394b interface 14A, 14B. Interfaces 14A and 14B may be provided on plug-in cards or integrated into the circuitry of camera 11 and computer 12 or the like. Data from camera 11 is carried by way of a suitable cable 16 between interface 14A and interface 14B. However, the length of cable 16 is limited to approximately 4.5 m. This is limiting in the case where it is desired to locate camera 11 more than 4.5 m away from computer 12.

FIG. 2 shows a computer system 20 according to an example embodiment of this invention. Computer system 20 is similar to computer system 10 except that an intermediate data link 21 has been added. In the illustrated embodiment, intermediate data link 21 comprises a gigabit Ethernet data connection. Intermediate data link 21 comprises first and second data converters 22A and 22B interconnected by a gigabit Ethernet segment 25.

In some embodiments, ethernet link 25 implements only the gigabit ethernet physical layer. It is not mandatory that data converters 22 have MAC addresses or implement OSI layer 2 or higher layers of the gigabit ethernet protocol. Frames of data transmitted over ethernet link 25 do not need to satisfy any particular formatting requirements other than the minimum framing required for operation of the ethernet physical layer to transport data between data converters 22A and 22B. Thus, data converters 22A and 22B can be relatively simple devices. Using minimal framing can reduce overhead and frame size. Optionally a MAC layer overhead could be added to permit standard layer 2 Ethernet networking devices such as switches to be present in ethernet segment 25. Providing such devices can increase the distance over which ethernet segment 25 can extend at the expense of latency.

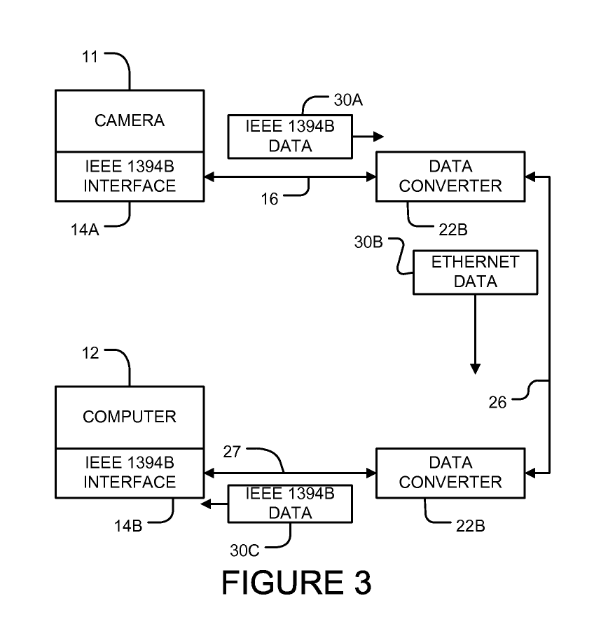

FIG. 3 shows data flows in computer system 20. Camera 11 generates a first IEEE 1394b data stream 30A. Data stream 30A is carried on cable 16 to first data converter 22A. Data converter 22A encapsulates the data from data stream 30A into a gigabit Ethernet data stream 30B that travels from data converter 22A to data converter 22B over a suitable medium 26. At data converter 22B data is extracted from Ethernet data stream 30B and transmitted to computer 12 as an IEEE 1394b data stream 30C over a cable 27.

The IEEE 1394b interface transfers data as a serial bit stream at a nominal rate of 983.4 Mbit/s. A gigabit ethernet link can transfer data at a nominal rate of approximately 1000 Mbit/s. Therefore, gigabit ethernet link 25 has a sufficient bandwidth to encapsulate the entire 1394b bit stream 30A as payload in Ethernet data stream 30B even when Ethernet protocol overhead is taken into account.

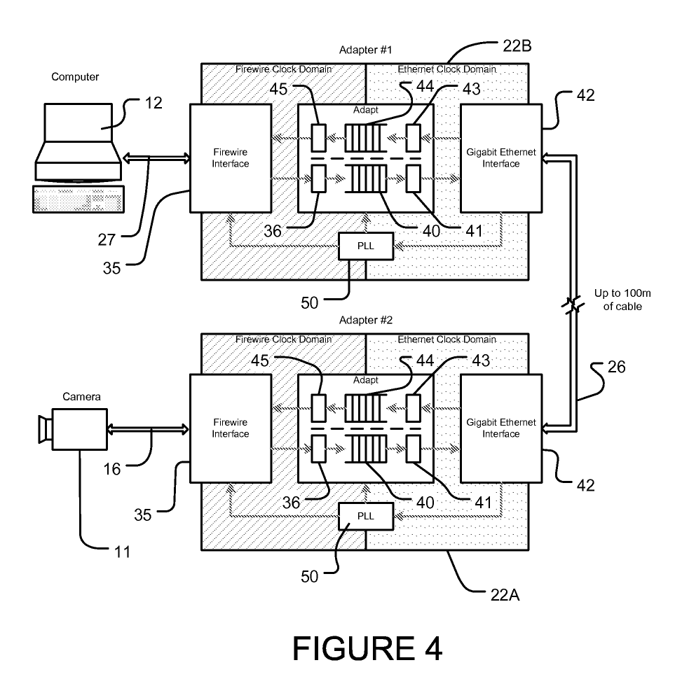

FIG. 4 shows an example embodiment of computer system 20 in more detail. In the illustrated embodiment, each data converter has an IEEE 1394 interface 35, adaptation circuitry 37 and an ethernet PHY device 42. IEEE 1394 data is received at an IEEE 1394 interface 35 of data converter 22A. The data from the 1394b bit stream 30A is converted from a serial data stream to a parallel data stream suitable for transmission in ethernet frames by serial to parallel converter 36. The serial-to-parallel conversion may be performed by off the shelf components. Serial-to-parallel conversion may be performed in any suitable manner. In a prototype embodiment, serial data is collected into 10-bit words transferred at a rate of 98.304 Mwords/s. This operation may be performed by a commercially-available deserializer having a 10-bit output, for example.

In the prototype embodiment, the 10-bit data stream is further parallelized into 40-bit words at a rate of 24.576 Mwords/s. These 40-bit words are written to a rate adaptation FIFO 40 so that the data can cleanly cross clock domains to the Ethernet data stream. This may be done, for example, by providing four 10-bit wide registers and directing 10-bit words of the 10-bit data stream into each of the four registers in turn until each of the registers has received a 10-bit word. Then, the four 10-bit words can be clocked into corresponding positions at the input of a 40-bit wide FIFO 40. Allocation of 10-bit words to the registers may be coordinated by providing a modulo-4 counter that controls switching logic to direct each 10-bit word into the next register.

The data is read out of rate adaptation FIFO 40 at a rate of 25 Mwords/s and broken up into standard 8-bit wide bytes. Ethernet framing data is then added to the byte stream. These steps are performed by data formatting logic 41. The resulting data is passed to an Ethernet PHY device 42 one byte at a time at a rate of 125 Mbytes/s. Only the minimal amount of framing overhead required by ethernet PHY device 42 needs to be added to the data stream. Data may be provided to Ethernet PHY device 42 in frames approximately 1300 bytes in length to minimize the percentage of bandwidth lost to framing overhead. Ethernet PHY device 42 transmits the frames over medium 26 (which could comprise a suitable cable or optical fibre for example). In some embodiments, media 26 comprises a standard Category 5 cable.

At the other end of medium 26, a similar process is followed in reverse to recreate the original 1394b serial bit stream. In the illustrated embodiment, ethernet PHY device 42 of data converter 22B receives ethernet frames. A data formatting circuit 43 strips ethernet frame data, assembles received data into 40-bit words and places the words into FIFO 44. At the output of FIFO 44 a parallel to serial converter 45 formats the data into a serial data stream that is transmitted by IEEE 1394 interface 35.

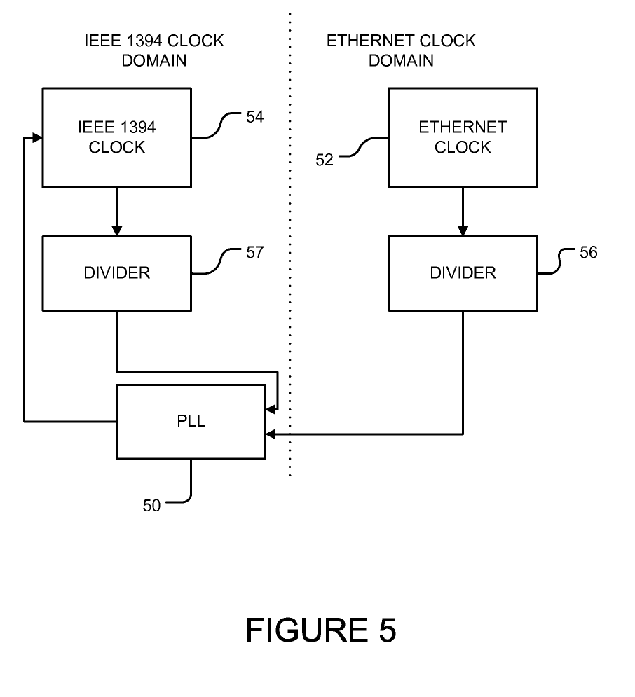

A feature of the illustrated embodiment is the mechanism provided to maintain synchronization of the 1394b and Ethernet clock domains. An embodiment of this mechanism is illustrated in FIG. 5. Since the raw 1394b bit stream is being transferred across Ethernet link 25 without any insertions, deletions, or other modifications, the 1394b clocks on both adapter devices should be synchronized so as not to disrupt the data flow. The illustrated apparatus achieves this by taking advantage of the fact that the gigabit Ethernet interface synchronizes its data clocks at both ends of the Ethernet link. That is, ethernet PHY devices 42 each comprise a clock and the two ethernet clocks are kept synchronized by operation of the gigabit ethernet protocol. The 1394b clocks at either end of the ethernet link are kept synchronized with one another by synchronizing each of the 1394b clocks to a corresponding clock of the Ethernet clock domain.

In the illustrated embodiment, each data converter 22 has a Phase Locked Loop (PLL) 50, an Ethernet clock 52 and an IEEE 1394 clock 54. IEEE 1394 clock 54 is synchronized to Ethernet clock 52 by dividing both clocks to a common frequency and locking the IEEE 1394 clock 54 to the Ethernet clock 52 using Phase Locked Loop (PLL) 50. In the illustrated embodiment, a first divider 56 divides the clock signal from ethernet clock 52 by a first factor and a second divider 57 divides the clock signal from IEEE 1394 clock 54 by a second factor such that outputs of first and second dividers 56 and 57 are at a common frequency.

In an example embodiment, ethernet clock 52 generates a 125 MHz clock signal for coordinating data transport over ethernet link 25. Ethernet clocks 52 at either end of Ethernet link 25 are locked to one another (the two clocks 52 effectively provide one clock domain). This is done automatically by the operation of the gigabit ethernet protocol.

IEEE 1394 clock 54 generates a clock signal at 98.304 MHz. In the example embodiment, dividers 56 and 57 each divide by a factor selected to produce an 8 kHz output. These outputs are passed to a phase comparator of PLL 50 which generates an output signal 59 that controls the frequency of IEEE 1394 clock 54. Any differences between the phases of the two 8 kHz signals causes output signal 59 to have a value such that it causes clock 54 to either speed up or slow down. Thus the frequency of IEEE 1394 clock 54 is controlled so that the phase difference between the 8 kHz signals remains constant. At this point, clocks 52 and 54 are locked.

When clocks 52 and 54 are locked there are no data overflows or underflows in FIFOs 40 or 44 or in other parts of data converters 22.

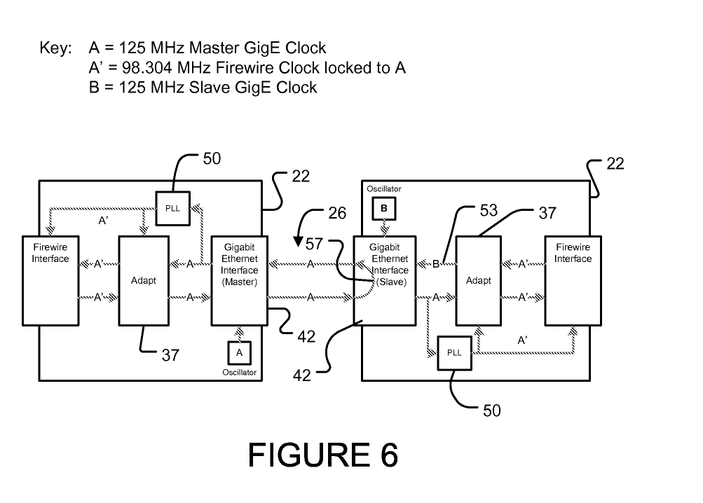

FIG. 6 is a schematic diagram illustrating different clock domains in apparatus according to an example embodiment. In the illustrated embodiment, the ethernet clock of one of data converters 22 is configured as a master clock. This may be done automatically by the operation of ethernet PHY devices 42. IEEE 1394 clocks in both data converters 22 are directly or indirectly locked to the master ethernet clock. As shown in FIG. 6, the transfer of data from adaptation circuitry 37 to ethernet PHY device 42 in the data converter 22 of the ethernet slave clock (indicated by line 53) may be clocked by the ethernet slave clock. Loop 57 indicates that the transfer of data from the ethernet PHY device 42 hosting the slave ethernet clock is clocked according to the master ethernet clock.

Embodiments of the invention permit 800 megabit per second IEEE-1394b data to be transmitted over common Category 5 cable. This may be done over distances significantly longer (e.g. 4 times longer or more, in some cases 20 times longer or more) than the 4.5 m maximum length of an IEEE 1394b cable.

The invention may be embodied in a range of ways including as:

data converters as described herein;

computer systems as described herein; and

data transmission methods as described herein.

The example embodiment described herein obtains the benefit of ethernet connectivity (low cost, reliable interface, long cables, ubiquitous infrastructure) while transparently maintaining the advantages of IEEE 1394b connectivity. The example embodiment described herein provides a cost-effective way to extend the distances over which existing cameras and other devices having IEEE 1394 interfaces can communicate.

Where a component (e.g. a PLL, circuit, etc.) is referred to above, unless otherwise indicated, reference to that component should be interpreted as including as equivalents of that component any component which performs the function of the described component (i.e., that is functionally equivalent), including components which are not structurally equivalent to the disclosed structure which performs the function in the illustrated exemplary embodiments of the invention.

As will be apparent to those skilled in the art in the light of the foregoing disclosure, many alterations and modifications are possible in the practice of this invention without departing from the spirit or scope thereof. For example:
It is convenient, but not mandatory, to parallelize the data as described above. 1394b data could be broken into 8-bit words directly instead of 10-bit words. Such embodiments would not have an intermediate stage in which data is presented in 40-bit data words as described above.
The conversion to 8-bit words could be done in the Ethernet clock domain after adaptation FIFOs 40. This may permit satisfactory operation with smaller-capacity FIFOs 40. For example, FIFO 40 may have a width, such as 10-bits for example, equal to a width of words output by a deserializer.
The IEEE 1394 clock domains could be synchronized using ‘adaptive clock recovery’ by monitoring FIFO depth. Adaptive clock recovery is described, for example, in U.S. Pat. No. 6,721,328. This would decouple the operation of the IEEE 1394 clocks from the clock(s) of the Ethernet clock domain.
Gigabit ethernet link 25 could be replaced with a link operating on another protocol having capacity sufficient to carry data at a rate at least equal to that of IEEE 1394b interfaces 14A and 14B. In some such embodiments clocks at either end of the link are locked to one another and IEEE 1394 clocks are locked to the clocks associated with the link.
   Accordingly, the scope of the invention is to be construed in accordance with the substance defined by the following claims.

What is claimed is:

1. A method for transferring data between a source device and a destination device, the method comprising:
providing a data transfer path interconnecting the source device and the destination device, the data transfer path comprising a source interface, an intermediate link and a destination interface, the source interface operable to transfer data under a first protocol to the intermediate link, the intermediate link operable to transfer the data under a second protocol to the destination interface, and the destination interface operable to transfer the data under the first protocol to the destination device;
synchronizing a clock domain of the source interface to a clock domain of the intermediate link and synchronizing a clock domain of the destination interface to the clock domain of the intermediate link; and,
transferring data between the source device and the destination device by way of the data transfer path.

2. A method according to claim 1 wherein the intermediate link comprises source and destination data converters respectively connected to the source and destination interfaces, the source and destination data converters each comprising an intermediate link clock; and
the method comprises synchronizing the intermediate link clocks of the source and destination data converters, synchronizing a clock of the source interface to the intermediate link clock of the source data converter and synchronizing a clock of the destination interface to the intermediate link clock of the destination data converter.

3. A method according to claim 2 wherein synchronizing the intermediate link clocks of the source and destination data converters is performed automatically by operation of the second protocol.

4. A method according to claim 3 wherein synchronizing the clock of the source interface to the intermediate link clock of the source data converter comprises:
dividing clock signals associated with the clock domains of the source interface and intermediate link to yield a divided source interface clock signal and a divided intermediate link clock signal having a common frequency; and
locking the divided source interface clock signal to the divided intermediate link clock signal by way of a phase locked loop.

5. A method according to claim 4 wherein the second protocol has a bit-rate greater than or equal to a bit-rate of the first protocol

6. A method according to claim 5 wherein the first protocol is an IEEE 1394 protocol.

7. A method according to claim 6 wherein the second protocol is gigabit Ethernet.

8. A method according to claim 5 wherein the first protocol comprises a serial protocol.

9. A method according to claim 8 comprising, at the source data converter, receiving the data from the source interface and arranging the data into 8-bit words before transferring the data across the intermediate link.

10. A method according to claim 8 comprising, at the source data converter, deserializing the data, and arranging the deserialized data into 40-bit words before transferring the data across the intermediate link.

11. A method according to claim 10 wherein transferring the data across the intermediate link comprises breaking the 40-bit words into 8-bit bytes, arranging pluralities of the bytes in frames according to the second protocol and carrying the frames to the destination data converter over the intermediate link.

12. A method according to claim 11 comprising passing the 40-bit words through a FIFO and clocking the FIFO using a signal from the clock of the source interface.

13. A method according to claim 1 wherein the first protocol comprises a serial protocol.

14. Apparatus for transferring data between a source device and a destination device, the apparatus comprising:
a data transfer path interconnecting the source device and the destination device, the data transfer path comprising a source interface, an intermediate link and a destination interface, the source interface operable to transfer data from the source device under a first protocol to the intermediate link, the intermediate link operable to transfer the data under a second protocol to the destination interface, and the destination interface operable to transfer the data under the first protocol to the destination device;
wherein the source interface, intermediate link and destination interface each comprises a clock domain and the clock domains of the source interface and destination interface are each locked to the clock domain of the intermediate link.

15. Apparatus according to claim 14 wherein:
the intermediate link comprises source and destination data converters respectively connected to the source and destination interfaces, the source and destination data converters each comprising an intermediate link clock;
one of the intermediate link clocks is a master clock and the other one of the intermediate link clocks is a slave clock synchronized to the master clock by operation of the second protocol;
the source data converter comprises a first divider connected to divide a clock signal from the intermediate link clock of the source data converter and a second divider connected to divide a clock signal from a clock of the source interface to yield divided clock signals having a common frequency;
a phase locked loop connected to receive the divided clock signals and to control a frequency of the clock of the source interface to maintain constant a relative phase of the divided signals.

16. Apparatus according to claim 15 comprising, in the data path connecting the source interface to the intermediate link a deserializer and a FIFO in series, the FIFO clocked by the clock of the source interface.

17. Apparatus according to claim 16 comprising, in the data path connecting the intermediate link to the destination interface, a FIFO in series with a serializer, the FIFO clocked by a clock of the destination interface.

18. Apparatus according to claim 17 wherein the first protocol comprises an IEEE 1394 protocol.

19. Apparatus according to claim 18 wherein the second protocol comprises a gigabit Ethernet protocol.

20. Apparatus according to claim 15 wherein the intermediate link comprises first and second ethernet PHY devices connected by a cable and the first and second ethernet PHY devices respectively comprise the master clock and the slave clock.

21. Apparatus according to claim 15 wherein the first protocol comprises an IEEE 1394 protocol, the source data converter comprises an IEEE 1394 cable for connecting to the source device and the destination data converter comprises an IEEE 1394 cable for connecting to the destination device.

22. Apparatus according to claim 20 in combination with the source device and the destination device wherein:
the destination device comprises a computer;
the source interface comprises an IEEE 1394 interface interfaced to the computer; and
the source device comprises a peripheral connected to the computer.

23. Apparatus according to claim 22 wherein the source device comprises a camera.

24. Apparatus according to claim 21 wherein the first and second ethernet PHY devices are configured to implement the OSI layer 1 physical layer of the gigabit ethernet protocol and not OSI layer 2 of the gigabit ethernet protocol.

25. Apparatus for transmitting data between first and second devices, the apparatus comprising:
source and destination interfaces operative to carry data according to a first protocol;
an intermediate link operative to carry data according to a second protocol, the intermediate link comprising source and destination data converters respectively in data communication with the source and destination interfaces;
wherein each of the data converters comprises synchronization circuitry operative to synchronize a clock associated with the first protocol to a clock signal associated with the second protocol.

26. A data converter comprising:
a first interface for receiving data in a first protocol;
a second interface for transmitting the data in a second protocol;
a first clock providing a first clock signal to the first interface;
a second clock providing a second clock signal to the second interface;
adapter circuitry for passing the data between the first and second interfaces; and,
synchronization circuitry for synchronizing the first and second clocks, the synchronization circuitry comprising first and second dividers having inputs connected to divide the first and second clock signals respectively and outputs connected to a phase locked loop operative to control a frequency of the first clock to maintain constant a relative phase of signals at the outputs of the first and second dividers.

27. A data converter according to claim 26 wherein the first interface comprises an IEEE 1394 interface.

28. An adapter for carrying data between a computer and a peripheral, the adapter comprising:
a first IEEE 1394 connector for connecting to an IEEE 1394 interface of the computer;
a second IEEE 1394 connector for connecting to an IEEE 1394 interface of the peripheral;
a first data converter connected to the first IEEE 1394 connector;
a second data converter connected to the second IEEE 1394 connector; and,
an intermediate data link connecting the first and second data converters;
wherein the data converters each comprise:
a first IEEE 1394 interface configured for sending and receiving data according to an IEEE 1394 protocol to and from the connected IEEE 1394 connector;
a second interface configured for receiving and sending the data according to a second protocol from and to the other data converter by way of the intermediate data link;
a first clock providing a first clock signal to the first interface;
a second clock providing a second clock signal to the second interface;
adapter circuitry for passing the data in either direction between the first and second interfaces; and,
synchronization circuitry for synchronizing the first and second clocks, the synchronization circuitry comprising first and second dividers having inputs connected to divide the first and second clock signals respectively and outputs connected to a phase locked loop operative to control a frequency of the first clock to maintain constant a relative phase of signals at the outputs of the first and second dividers.
